(19) United States
(12) Patent Application Publication
(10) Pub. No.: US 2024/0404010 A1
(43) Pub. Date: Dec. 5, 2024

(54) ELECTRONIC DEVICE AND CONTROLLING METHOD THEREOF

(71) Applicant: SAMSUNG ELECTRONICS CO., LTD., Suwon-si (KR)

(72) Inventors: Praful MATHUR, Bengaluru (IN); Siddhant KHANDELWAL, Bengaluru (IN); Mrinmoy SEN, Bengaluru (IN); Sai Pradyumna CHERMALA, Bengaluru (IN); Nazrinbanu Nurmohammad NAGORI, Bengaluru (IN); Venkat Ramana PEDDIGARI, Bengaluru (IN); Darshana Venkatesh MURTHY, Bengaluru (IN); Moonhwan JEONG, Suwon-si (KR)

(73) Assignee: SAMSUNG ELECTRONICS CO., LTD., Suwon-si (KR)

(21) Appl. No.: 18/798,017

(22) Filed: Aug. 8, 2024

Related U.S. Application Data
(63) Continuation of application No. PCT/KR2023/001805, filed on Feb. 8, 2023.

(30) Foreign Application Priority Data
Feb. 8, 2022 (IN) 202241006700
Aug. 2, 2022 (IN) 202241006700

(51) Int. Cl. G06T 5/20; G06T 5/50; G06T 7/11; G06T 7/136; G06V 20/70

(52) U.S. Cl. CPC G06T 5/20; G06T 5/50; G06T 7/11; G06T 7/136; G06V 20/70; G06T 2207/20212

(57) ABSTRACT

A method for generating one or more artifact images is disclosed. The method includes obtaining one or more artifact free images and one or more artifacts represented by one or more artifact masks; obtaining a region of interest (ROI) mask identifying one or more ROIs in the one or more artifact free images; generating one or more transformed artifact masks by applying at least one localization parameter amongst a plurality of localization parameters to the one or more artifact masks; generating one or more localized artifact masks by placing the one or more transformed artifact masks on the ROI mask; and generating one or more artifact images by combining the one or more artifact free images and the one or more localized artifact masks.

### CROSS-REFERENCE TO RELATED APPLICATIONS

This application is a bypass continuation application of International Patent Application No. PCT/KR2023/001805, filed on Feb. 8, 2023, which claims priority to Indian patent application No. 202241006700, filed on Feb. 8, 2022, and Indian patent application No. 202241006700, filed on Aug. 2, 2022, the disclosures of which are incorporated herein by reference in their entireties.

### BACKGROUND

### 1. Field

Apparatuses and methods consistent with example embodiments relate to an artifact synthesis framework, and more particularly to a method and system for generating one or more artifact images using one or more artifact masks.

### 2. Description of the Related Art

Traditionally, developing and training successful Artificial Intelligence (AI) and Machine Learning (ML) models needs access to large amounts of high-quality data. However, collecting such data is challenging for the following reasons:

Some types of data are costly to collect. Specifically, when the scale of data requirement for computer vision tasks could be as high as 100,000 training dataset. For example, artifact removal models such as shadow/reflection removal require paired data which is highly expensive.

Data collection itself is a time consuming process. For any model development, since data is a basic necessity, synthetic data allows developers to continue developing new and innovative products and solutions when the data necessary to do so otherwise wouldn't be present or immediately available.

Paired data (i.e., an artifact image and a corresponding artifact free image) collection has following challenges:

Paired data cannot be obtained for artifacts caused by natural occulders such as trees, walls, buildings etc. This limits the diversity in data collection. This is specific to shadow artifact data collection.

There can be errors in paired data due to environmental changes and human movements.

Very difficult to obtain paired data with pets/animals.

The primary problem that data scientists face is the collection and handling of data. Companies often have difficulty acquiring large amounts of data to train an accurate model within a given time frame. Hand-labeling data is a costly, slow way to acquire data.

Training supervised machine learning models for removing artifacts such as shadows, glares from images need a large amount of paired dataset. Capturing paired images (i.e., a pair of an artifact image and an artifact free image) is subject to constraints that limits the diversity and complex variations required in paired dataset. Existing synthetic data generation techniques has the following limitations:

No unified framework for jointly learning the realistic location and realistic illumination of foreground artifact masks as per background scene.

Conventional generative adversarial network (GAN) based data synthesis framework provides no control over localization and illumination properties of foreground artifacts to be synthesized that makes it difficult to train and synthesize complex variations.

A single image that costs $6 from a labeling service can be artificially generated for six cents.

Currently, related systems and methods for correcting user identified artifacts in light field images do not provide any framework to synthesize artifacts. In the related systems and methods, a user guidance is needed for detecting location of the artifact. An object synthesis via composition method is performed. A related synthesizer module uses a deep learning (DL) network to predict the affine matrix to be applied to an object mask and then composite on a background image. This method does not disclose how to explicitly identify the location for synthesis. The synthesizer module only predicts 2D affine matrix and does not disclose any method to change the illumination of the object mask. It is a conventional Generative Adversarial Network (GAN) based approach to find realistic locations and the same approach cannot work for artifacts as the artifacts cannot span across arbitrary regions in an image but objects can span. Also, there is no control in this approach to synthesize objects at a desired location.

### SUMMARY

Example embodiments address at least the above problems and/or disadvantages and other disadvantages not described above. Also, the example embodiments are not required to overcome the disadvantages described above, and may not overcome any of the problems described above.

According to an aspect of the present disclosure, a method for controlling an electronic device may include: obtaining one or more artifact free images and one or more artifacts represented by one or more artifact masks; obtaining a region of interest (ROI) mask identifying one or more ROIs in the one or more artifact free images; generating one or more transformed artifact masks by applying at least one localization parameter amongst a plurality of localization parameters to the one or more artifact masks; generating one or more localized artifact masks by placing the one or more transformed artifact masks on the ROI mask; and generating one or more artifact images by combining the one or more artifact free images and the one or more localized artifact masks.

The method of controlling the electronic device may include generating one or more varied intensity images by applying one or more illumination parameters associated with the one or more artifact free images to the one or more artifact free images and wherein the generating the one or more artifact images comprises generating the one or more artifact images by combining the one or more artifact free images, the one or more localized artifact masks and the one or more varied intensity images.

The method of controlling the electronic device 100 may include analyzing the one or more artifact images to detect a presence of the one or more artifacts represented by the one or more localized artifact masks in the one or more artifact images, determining that the one or more artifacts represented by the one or more localized artifact masks is present in the one or more artifact images and producing the one or more artifact images comprising the one or more artifacts represented by the one or more localized artifact masks as an output.

The method of controlling the electronic device 100 may include providing feedback for varying one of the plurality of localization parameters and one or more illumination parameters in response to determining that the one or more artifacts represented by the one or more localized artifact masks is absent in the one or more artifact images.

The determining the one or more ROI as the ROI mask may include obtaining, from the one or more artifact free images, one or more segmentation masks of one or more categories depicting contextual information associated with the plurality of ROI and obtaining the ROI mask based on the one or more segmentation masks of the one or more categories.

The plurality of localization parameters may be determined based on computing a size and dimensions associated with the ROI mask and adjusting a plurality of pre-defined localization parameters of the one or more artifact masks according to the size and the dimensions of the ROI mask and generating the plurality of localization parameters.

The method of controlling the electronic device 100 may include varying the plurality of pre-defined localization parameters of the artifact mask within a range to generate at least one other set of plurality of localization parameters, applying the at least one other set of the plurality of localization parameters on the one or more artifact masks to generate at least one other transformed artifact mask and generating at least one other localized artifact mask by placing the at least one other transformed artifact mask on the ROI mask for further generating at least one other artifact image.

The plurality of localization parameters may include at least one of a translation, a rotation, a shear, a flip, and a scaling associated with the one or more artifact masks.

The one or more artifact may be a region of shadow casted by one or more of an object, a scene, and a living being and the one or more artifact masks represent a location of the one or more artifacts in the image using a binary mask image.

The one or more artifact free images may be an image of one or more of an object, a scene, and a living being.

The one or more artifacts represented by the one or more artifact masks and the one or more artifact free images may be pre-stored in the electronic device.

The controlling method of the electronic device according to an embodiment may be implemented as a program and provided to the electronic device. In particular, a program including a controlling method of the electronic device may be stored in a non-transitory computer readable medium and provided.

According to another aspect of the present disclosure, an electronic device may include: a memory storing one or more instructions; and a processor configured to execute the one or more instructions to: obtain, from the memory, one or more artifact free images, and one or more artifacts represented by one or more artifact masks; obtaining a region of interest (ROI) mask identifying one or more ROIs in the one or more artifact free images; generate one or more transformed artifact masks by applying at least one localization parameter amongst a plurality of localization parameters to the one or more artifact masks; generate one or more localized artifact masks by placing the one or more transformed artifact masks on the ROI mask; and generate one or more artifact images by combining the one or more artifact free images and the one or more localized artifact masks.

The processor may generate one or more varied intensity images by applying one or more illumination parameters associated with the one or more artifact free images to the one or more artifact free images and generate the one or more artifact images by combining the one or more artifact free images, the one or more localized artifact masks and the one or more varied intensity images.

The processor may analyze the one or more artifact images to detect a presence of the one or more artifacts represented by the one or more localized artifact masks in the one or more artifact images, determine that the one or more artifacts represented by the one or more localized artifact masks is present in the one or more artifact images and produce the one or more artifact images comprising the one or more artifacts represented by the one or more localized artifact masks as an output.

The processor may provide feedback for varying one of the plurality of localization parameters and one or more illumination parameters in response to determining that the one or more artifacts represented by the one or more localized artifact masks is absent in the one or more artifact images.

According to another aspect of the present disclosure, there is provided a non-transitory computer-readable storage medium storing a program that is executable by a processor to perform a method of controlling an electronic device. The method may include: obtaining an artifact free image and an artifact mask identifying an artifact; obtaining a localized artifact mask by applying at least one localization parameter to the artifact mask and adjusting a position of the artifact mask to overlap with a region of interest (ROI) included in the artifact free image; and obtaining an artifact image by combining the artifact free image with the localized artifact mask.

The at least one localization parameter may include at least one of a translation, a rotation, a shear, a flip, and a scaling associated with the artifact mask.

The method may further include: determining the at least one localization parameter based on a size and a dimension of the ROI.

### BRIEF DESCRIPTION OF THE DRAWINGS

The above and/or other aspects will be more apparent by describing certain example embodiments, with reference to the accompanying drawings, in which:

FIG. 1 illustrates an environment comprising a system, one or more artifacts represented by one or more artifact masks and one or more artifact free images generating one or more artifact images, in accordance with an embodiment of the present disclosure;

FIG. 2 illustrates a schematic block diagram of the system configured to generate one or more artifact images using one or more artifacts masks, in accordance with an embodiment of the present disclosure;

FIG. 3 illustrates an operational flow diagram depicting a process for generating one or more artifact images using one or more artifacts masks, in accordance with an embodiment of the present disclosure;

FIG. 4A illustrates an operational flow diagram depicting a process for generating one or more localized artifact masks, in accordance with an embodiment of the present disclosure;

FIG. 4B illustrates an operational flow diagram depicting a process for generating one or more synthetic artifact images, in accordance with an embodiment of the present disclosure;

FIG. 4C illustrates an operational flow diagram depicting a process for generating one or more synthetic artifact images by using a utility assessment module, in accordance with an embodiment of the present disclosure;

FIG. 5 illustrates an operational flow diagram depicting a process for determining a ROI mask, in accordance with an embodiment of the present disclosure;

FIG. 6 illustrates an operational flow diagram depicting a process for generating one or more transformed artifact masks, in accordance with an embodiment of the present disclosure; and

FIG. 7 illustrates an operational flow diagram depicting a process for generating one or more artifact images by the synthesizer engine, in accordance with an embodiment of the present disclosure;

FIG. 8 illustrates a use case diagram depicting results related to a Shadow Detector (SoTa), in accordance with an embodiment of the present disclosure;

FIG. 9 illustrates another use case diagram depicting a large-scale artifact synthesis for synthetic dataset, in accordance with an embodiment of the present disclosure;

FIG. 10 illustrates a flow diagram depicting a method for generating one or more artifact images using one or more artifacts masks, in accordance with an embodiment of the present disclosure; and

FIG. 11 illustrates a flow diagram depicting a method for generating illumination of one or more artifacts, in accordance with an embodiment of the present disclosure.

FIG. 12 is a flowchart illustrating a method for controlling an electronic device according to an embodiment.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

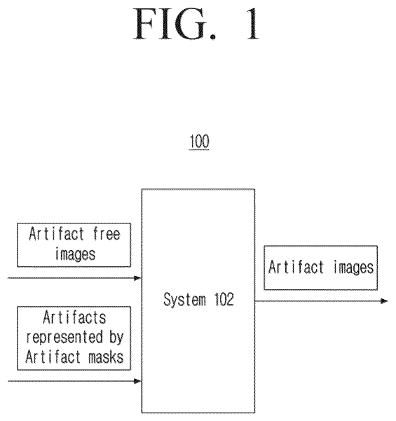

FIG. 1 illustrates an environment 100 comprising a system 102, one or more artifacts represented by one or more artifact masks and one or more artifact free images generating one or more artifact images, in accordance with an embodiment of the present disclosure. The system 102 may be implemented in an electronic device. In an embodiment, examples of the electronic device may include, but are not limited to, a smartphone, a Personal Computer, a smartphone, a laptop, a tablet, and a server. The system 102 may be configured to generate the one or more artifact images by using the one or more artifact masks associated with the one or more artifacts. The system 102 may be configured to work based on an artifact synthesis framework that may be used to synthesize one or more realistic artifacts. Additionally, the artifact synthesis framework may provide a flexibility to target tailor made use-cases based on one or more failure cases of a model and generate data that is difficult to procure in large numbers.

The one or more realistic artifacts may be the one or more artifacts. The artifact synthesis framework may be used to synthesize the one or more artifacts such as a shadow, and a glare. The synthesizing may be performed using a synthetic data generation framework. The one or more artifact images may be an image including at least one artifact from the one or more artifacts. In an embodiment, the one or more artifacts may be blended on the image from the one or more artifact free images.

According to embodiments of the present disclosure, the system 102 may be configured to obtain the one or more artifact free images and the one or more artifacts including the one or more artifact masks. The one or more artifact free images and the one or more artifacts with the one or more artifact masks may be obtained from a memory of the system 102. The one or more artifact masks may represent the one or more artifacts. The system 102 may be configured to use the one or more artifact free images and the one or more artifact masks as an input to generate the one or more artifact images.

Subsequent to obtaining the one or more artifact free images and the one or more artifacts including the one or more artifact masks, the system 102 may be configured to determine one or more Region Of Interests (ROI) as a ROI mask. The one or more ROI may be determined from a number of ROI in the one or more artifact free images. In an embodiment, the number of ROI may include one or more regions in the one or more artifact free images that may be modified for generating the one or more artifact images.

Upon determining the one or more ROI, the system 102 may be configured to generate one or more transformed artifact masks. The one or more transformed artifact masks may be generated by modifying the one or more artifact masks related to the one or more artifacts. The one or more artifact masks may be modified by applying at least one localization parameter from a number of localization parameters to the one or more artifact masks.

In response to generating the one or more transformed artifact masks, the system 102 may be configured to generate one or more localized artifact masks. The one or more localized artifact masks may be generated by placing the one or more transformed artifact masks on the ROI mask determined from the number of ROI.

In continuation to generating the one or more localized artifact masks, the system 102 may be configured to generate one or more varied intensity images which represent images with different illumination levels. The one or more varied intensity images may be generated by modifying the one or more artifact free images. The one or more artifact free images may be modified by applying one or more illumination parameters to the one or more artifact free images. The one or more illumination parameters may be related to the one or more artifact free images.

Subsequently, the system 102 may be configured to generate the one or more artifact images by blending the one or more artifact free images and the one or more varied intensity images with the one or more localized artifact masks related to the one or more artifacts.

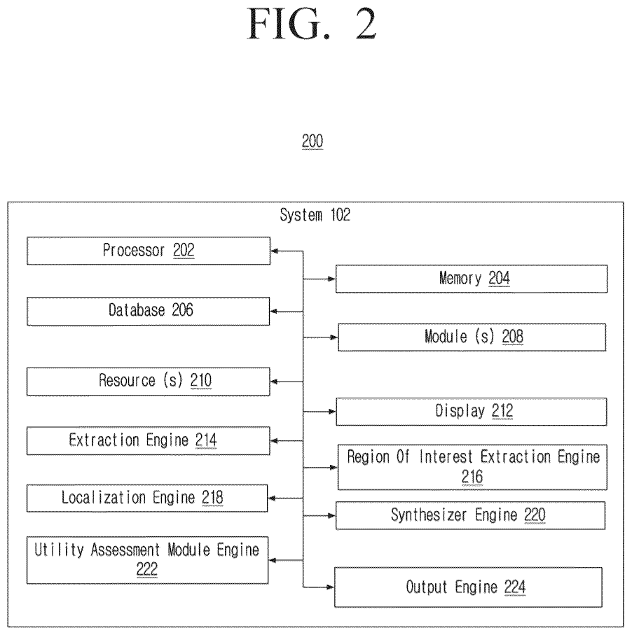

FIG. 2 illustrates a schematic block diagram 200 of the system 102 configured to generate one or more artifact images using one or more artifacts masks, in accordance with an embodiment of the present disclosure. The system 102 may be configured to generate the one or more artifact images from one or more artifact free images by performing an artifact synthesis on the one or more artifact free images received as input along with one or more artifacts. The one or more artifact masks may be related to the one or more artifacts received as the input. Examples of the one or more artifacts include, but are not limited to, a glare and a shadow. The system 102 may be implemented in an electronic device. In an embodiment, examples of the electronic device may include, but are not limited to, a smartphone, a Personal Computer, a smartphone, a laptop, and a tablet.

The system 102 may include a processor 202, a memory 204, database 206, module(s) 208, resource(s) 210, a display 212, an extraction engine 214 (or obtaining engine), an ROI extraction engine 216 (or ROI obtaining engine), a localization engine 218, a synthesizer engine 220, an Utility Assessment Module (UAM) engine 222, and an output engine 224. While the extraction engine 214, the ROI extraction engine 216, the localization engine 218, the synthesizer engine 220, the UAM engine 222, and the output engine 224 are illustrated as separate elements from the processor 202, embodiments of the present disclosure may be implemented such that the extraction engine 214, the ROI extraction engine 216, the localization engine 218, the synthesizer engine 220, the UAM engine 222, and the output engine 224 may be incorporated into the processor 202.

In an embodiment, the processor 202, the memory 204, the database 206, the module(s) 208, the resource(s) 210, the display 212, the extraction engine 214, the ROI extraction engine 216, the localization engine 218, the synthesizer engine 220, the UAM engine 222, and the output engine 224 may be communicatively coupled to one another.

The system 102 may be understood as a hardware or a configurable hardware including or operating with a software or logic-based program. In an example, the processor 202 may be a single processing unit or a number of units, all of which could include multiple computing units. The processor 202 may be implemented as one or more microprocessors, microcomputers, microcontrollers, digital signal processors, central processing units, processor cores, multi-core processors, multiprocessors, state machines, logic circuitries, application-specific integrated circuits, field-programmable gate arrays and/or any devices that manipulate signals based on operational instructions. Among other capabilities, the processor 202 may be configured to fetch and/or execute computer-readable instructions and/or data stored in the memory 204.

In an example, the memory 204 may include any non-transitory computer-readable medium known in the art including, for example, volatile memory, such as static random access memory (SRAM) and/or dynamic random access memory (DRAM), and/or non-volatile memory, such as read-only memory (ROM), erasable programmable ROM (EPROM), flash memory, hard disks, optical disks, and/or magnetic tapes. The memory 204 may include the database 206. The database 206 serves, amongst other things, as a repository for storing data processed, received, and generated by one or more of the processor 202, the memory 204, the module(s) 208, the resource(s) 210, the display 212, the extraction engine 214, the ROI extraction engine 216, the localization engine 218, the synthesizer engine 220, the UAM engine 222, and the output engine 224.

The module(s) 208, amongst other things, may include routines, programs, objects, components, data structures, etc., which perform particular tasks or implement data types. The module(s) 208 may also be implemented as, signal processor(s), state machine(s), logic circuitries, and/or any other device or component that manipulate signals based on operational instructions.

Further, the module(s) 208 may be implemented in hardware, as instructions executed by at least one processing unit, e.g., processor 202, or by a combination thereof. The processing unit may be a general-purpose processor that executes instructions to cause the general-purpose processor to perform operations or, the processing unit may be dedicated to performing the required functions. In another aspect of the present disclosure, the module(s) 208 may be machine-readable instructions (software) which, when executed by a processor/processing unit, may perform any of the described functionalities.

In some example embodiments, the module(s) 208 may be machine-readable instructions (software) which, when executed by a processor 202/processing unit, perform any of the described functionalities.

The resource(s) 210 may be physical and/or virtual components of the system 102 that provide inherent capabilities and/or contribute towards the performance of the system 102. Examples of the resource(s) 210 may include, but are not limited to, a memory (e.g., the memory 204), a power unit (e.g., a battery), a display (e.g., the display 212) etc. The resource(s) 210 may include a power unit/battery unit, a network unit, etc., in addition to the processor 202, and the memory 204.

The display 212 may display various types of information (for example, media contents, multimedia data, text data, etc.) to the system 102. The display 212 may include, but is not limited to, a liquid crystal display (LCD), a light-emitting diode (LED) display, an organic LED (OLED) display, a plasma cell display, an electronic ink array display, an electronic paper display, a flexible LCD, a flexible electrochromic display, and/or a flexible electrowetting display.

Continuing with the above embodiment, the extraction engine 214 may be configured to extract (or obtain) the one or more artifact free images and the one or more artifacts with the one or more artifact masks from the memory 204. The one or more artifact masks may represent the one or more artifacts.

Subsequent to extraction of the one or more artifact free images and the one or more artifacts, the ROI extraction engine 216 may be configured to determine one or more ROI as a ROI mask. The one or more ROI may be determined from a number of ROI in the one or more artifact free images. For determining the one or more ROI, the ROI extraction engine 216 may be configured to obtain one or more segmentation masks of one or more pre-defined categories from the one or more artifact free images extracted (or obtained) by the extraction engine 214.

The one or more pre-defined categories may depict contextual information associated with the plurality of ROI associated with the one or more artifact free images. In response to obtaining the one or more segmentation masks, the ROI extraction engine 216 may be configured to determine the one or more ROI as the ROI mask based on the one or more segmentation masks of the one or more pre-defined categories.

In response to determining the one or more ROI as the ROI mask, the localization engine 218 may be configured to generate one or more transformed artifact masks. The one or more transformed artifact masks may be generated by applying at least one localization parameter amongst a number of localization parameters to the one or more artifact masks. Examples of the number of localization parameters may include, but are not limited to, a translation, a rotation, a shear, a flip, and a scaling associated with the one or more artifact masks.

In an embodiment, the number of localization parameters may be determined based on a size and dimensions associated with the ROI mask, and a number of pre-defined localization parameters of the one or more artifact masks. For determining the number of localization parameters, the localization engine 218 may be configured to compute the size and the dimensions associated with the ROI mask. Upon computing, the localization engine 218 may be configured to adjust the number of pre-defined localization parameters of the one or more artifact masks according to the size and the dimensions of the ROI mask and thereby generate the number of localization parameters.

Continuing with the above embodiment, the localization engine 218 may be configured to generate one or more localized artifact masks by utilizing the one or more transformed artifact masks. The one or more transformed artifact masks may be placed on the one or more ROI determined as the ROI mask for generating the one or more localized artifact mask.

Subsequent to generation of the one or more localized artifact masks, the synthesizer engine 220 may be configured to generate one or more varied intensity images by utilizing one or more illumination parameters associated with the one or more artifact free images. The one or more illumination parameters may be determined based on an illumination intensity associated with the one or more artifacts free images using a Deep Learning (DL) network. Further, the one or more varied intensity images may be generated by the synthesizer engine 220 by varying the illumination intensity of the one or more artifacts free images based on the one or more illumination parameters.

The one or more varied intensity images may be the one or more artifact free images with a modified intensity. For modifying the intensity and generating the one or more varied intensity images, the synthesizer engine 220 may be configured to apply the one or more illumination parameters associated with the one or more artifact free images to the one or more artifact free images.

Moving forward, the synthesizer engine 220 may be configured to generate the one or more artifact images based on the one or more artifact free images, the one or more varied intensity images, and the one or more localized artifact masks associated with the one or more artifacts. The synthesizer engine 220 may be configured to blend the one or more artifact free images and the one or more varied intensity images with the one or more localized artifact masks. The synthesizer engine 220 may be configured to apply one or more edge softening operations on the one or more localized artifact masks for blending the one or more artifact free images and the one or more varied intensity images with the one or more localized artifacts masks for generating the one or more artifact images.

Continuing with the above embodiment, upon generation of the one or more artifact images, the UAM engine 222 may be configured to analyze the one or more artifact images. The analysis may be performed in order to detect whether the one or more artifacts represented by the one or more localized artifact masks is present in the one or more artifact images or not. In an embodiment, where it is determined that the one or more artifacts represented by the one or more localized artifact masks is present in the one or more artifact images, the output engine 224 may be configured to produce the one or more artifact images as an output.

The one or more artifact images produced by the output engine 224 may include the one or more artifacts represented by the one or more localized artifact masks. In an embodiment, where it is determined that the one or more artifacts represented by the one or more localized artifact masks is absent from the one or more artifact images, the UAM engine 222 may be configured to provide feedback to the localization engine 218 and the synthesizer engine 220 for varying one of the number of localization parameters and one or more illumination parameters such that new one or more artifact images including the one or more artifacts may be generated based on the a varied number of localization parameters and one or more varied illumination parameters.

In an embodiment of the present disclosure, the localization engine 218 may be configured to generate at least one other set of number of localization parameters. For generating the at least one other set of number of localization parameters, the localization engine 218 may be configured to vary the number of pre-defined localization parameters of the artifact mask within a range. Furthermore, the localization engine 218 may be configured to generate at least one other transformed artifact mask. The at least one other transformed artifact mask may be generated by applying the at least one other set of the number of localization parameters on the one or more artifact masks.

Moving forward, the localization engine 218 may be configured to place the at least one other transformed artifact mask on the ROI mask for generating at least one other localized artifact mask. Further, the at least one other localized artifact mask may be utilized by the synthesizer engine 220 for generating at least one other artifact image by using the one or more illumination parameters. Continuing with the above embodiment, the synthesizer engine 220 may be configured to adjust the one or more illumination parameters within a range to generate at least one other set of one or more illumination parameters. Further, the synthesizer engine 220 may be configured to generate at least one other varied intensity image by applying the at least one other set of one or more illumination parameters to the one or more artifact free images.

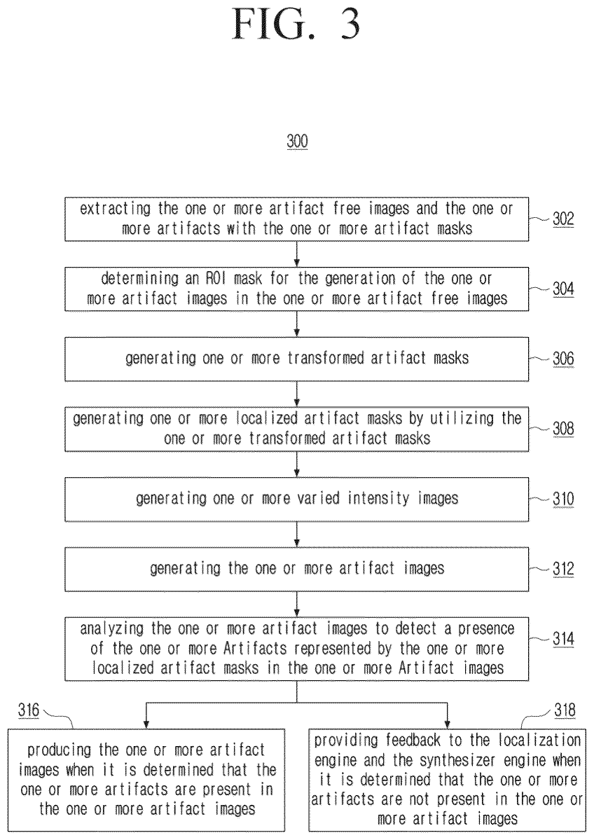

FIG. 3 illustrates an operational flow diagram depicting a process 300 for generating one or more artifact images using one or more artifacts masks, in accordance with an embodiment of the present disclosure. The one or more artifacts image may be generated by the system 102 as referred in FIG. 1 and FIG. 2. The one or more artifact images may include one or more artifacts. The one or more artifact masks may be related to the one or more artifacts. Examples of the one or more artifacts may include, but are not limited to, a region of shadow casted by one or more of an object, a scene, and a living being and the one or more artifact masks represents a location of the one or more artifacts in the image using a binary mask image. Further, the one or more artifact free images may be one or more of an image of one or more of an object, a scene, and a living being. The one or more artifacts represented by the one or more artifact masks and the one or more artifact free images may be pre-stored in the memory 214 as referred in FIG. 2.

Continuing with the above embodiment, the process 300 may include extracting (or obtaining) (step 302) the one or more artifact free images and the one or more artifacts represented with the one or more artifact masks pre-stored in the memory 204. The extraction (or obtaining) may be performed by the extraction engine 214 as referred in FIG. 2. The one or more artifact free images and the one or more artifact masks may serve as an input to generate the one or more artifact images. In an embodiment, two or more artifact masks from the one or more artifacts masks may be utilized for generating the one or more artifact images. Continuing with the above embodiment, the two or more artifacts masks may be merged with one another such that complex artifact masks may be generated and utilized for generating the one or more artifact images.

In response to extraction (or obtaining) of the one or more artifact free images and the one or more artifacts with the one or more artifact masks by the extraction engine 214, the process 300 may proceed towards determining (step 304) an ROI mask for the generation of the one or more artifact images in the one or more artifact free images. One or more ROI masks from a number of ROI masks may be determined as the ROI mask. The number of ROI may be present in the one or more artifact images. The ROI mask may be determined by the ROI extraction engine 216 as referred in FIG. 2. For determining the ROI mask, the process 300 may include obtaining one or more segmentation masks of one or more pre-defined categories from the one or more artifact free images. The one or more pre-defined categories may depict contextual information associated with the number of ROI. Upon obtaining the one or more segmentation masks, the process 300 may include determining the one or more ROI as the ROI mask based on the one or more segmentation masks of the one or more pre-defined categories.

Subsequent to determination of the one or more ROI as the ROI mask, the process 300 may include generating (step 306) one or more transformed artifact masks. The one or more transformed artifact images may be generated by the localization engine 218 as referred in FIG. 2. For generating the one or more transformed artifact masks, the process 300 may include applying at least one localization parameter amongst a number of localization parameters to the one or more artifact masks. Examples of the number of localization parameters may include, but are not limited to, a translation, a rotation, a shear, a flip, and a scaling associated with the one or more artifact masks. In an embodiment, the number of localization parameters may be determined based on a size and dimensions associated with the ROI mask, and a number of pre-defined localization parameters of the one or more artifact masks.

In an embodiment, the number of localization parameters may be determined based on computing the size and the dimensions associated with the ROI mask. Furthermore, upon computing the size and the dimensions associated with the ROI mask, the number of pre-defined localization parameters of the one or more artifact masks may be adjusted according to the size and the dimensions of the ROI mask and for generating the number of localization parameters.

Continuing with the above embodiment, the process 300 may proceed towards generating (step 308) one or more localized artifact masks by utilizing the one or more transformed artifact masks. The one or more localized artifact masks may be generated by the localization engine 218. Generating the one or more localized masks may include utilizing the one or more transformed artifact masks and placing the one or more transformed artifact masks on the one or more ROI determined as the ROI mask for generating the one or more localized artifact mask. In an embodiment, the process 300 may include generating by the localization engine 218, at least one other set of number of localization parameters by varying the number of pre-defined localization parameters of the artifact mask within a range. Furthermore, based on the at least one other set of number of localization parameters, the process 300 may include generating at least one other transformed artifact mask. The at least one other transformed artifact mask may be generated by applying the at least one other set of the number of localization parameters on the one or more artifact masks.

In response to generation of the one or more localized artifact masks, the process may proceed towards generating (step 310) one or more varied intensity images. The one or more varied intensity images may be generated by utilizing one or more illumination parameters related to the one or more artifact free images. The one or more illumination parameters may be subjected to a change in intensity for generating the one or more varied intensity images. The one or more illumination parameters may be determined based on an illumination intensity associated with the one or more artifacts free images using a Deep Learning (DL) network. Further, the one or more varied intensity images may be generated by the synthesizer engine 220 as referred in FIG. 2. The one or more varied intensity images may be the one or more artifact free images with a modified intensity. For modifying the intensity and generating the one or more varied intensity images, the process 300 may include applying the one or more illumination parameters related to the one or more artifact free images to the one or more artifact free images.

Moving forward, the process 300 may include placing the at least one other transformed artifact mask on the ROI mask for further generating at least one other artifact image for generating at least one other localized artifact mask. Further, the at least one other localized artifact mask may be utilized by the synthesizer engine 220 for generating at least one other artifact image by using the one or more illumination parameters.

Moving forward, the process 300 may include generating (step 312) the one or more artifact images by the synthesizer engine 220. The generation of the one or more artifacts images may be based on the one or more artifact free images, the one or more varied intensity images, and the one or more localized artifact masks related to the one or more artifacts. The generation may include blending the one or more artifact free images and the one or more varied intensity images with the one or more localized artifact masks. The process 300 may include applying one or more edge softening operations on the one or more localized artifact masks for blending the one or more artifact free images and the one or more varied intensity images with the one or more localized artifacts masks for generating the one or more artifact images.

In an embodiment, the process 300 may include adjusting by the synthesizer engine 220 the one or more illumination parameters within a range to generate at least one other set of one or more illumination parameters. Further, the synthesizer engine 220 may be configured to generate at least one other varied intensity image by applying the at least one other set of one or more illumination parameters to the one or more artifact free images.

Continuing with the above embodiment, upon generation of the one or more artifact images, the process 300 may proceed towards analyzing (step 314) the one or more artifact images. The analysis of the one or more artifact images may be performed by the UAM engine 222 as referred in FIG. 2. The analysis may be performed in order to detect a presence of the one or more artifacts represented by the one or more localized artifact masks in the one or more artifact images. In an embodiment, where it is determined that the one or more artifacts represented by the one or more localized artifact masks is present in the one or more artifact images, the process 300 may proceed towards step 316. In an embodiment, where it is determined that the one or more artifacts represented by the one or more localized artifact masks is not present in the one or more artifact images, the process 300 may proceed towards step 318.

Subsequently, the process may include producing (step 316) the one or more artifact images when it is determined that the one or more artifacts represented by the one or more localized artifact masks is present in the one or more artifact images. The one or more artifact images may be produced by the output engine 224 as referred in FIG. 2. The one or more artifact images produced by the output engine 224 may include the one or more artifacts represented by the one or more localized artifact masks.

In an embodiment where it is determined that the one or more artifacts represented by the one or more localized artifact masks is not present in the one or more artifact images, the process 300 may include providing (step 318) feedback to the localization engine 218 and the synthesizer engine 220. The feedback shared with the localization engine 218 may indicate a requirement for varying one of the number of localization parameters utilized for generation of the one or more artifact images. The feedback provided to the synthesizer engine 220 may indicate a requirement for varying the one or more illumination parameters utilized for generation of the one or more artifact images. The feedback may be provided such that one or more new artifact images may be generated based on the varied number of localization parameters and one or more varied illumination parameters with an increased visibility of the one or more artifacts.

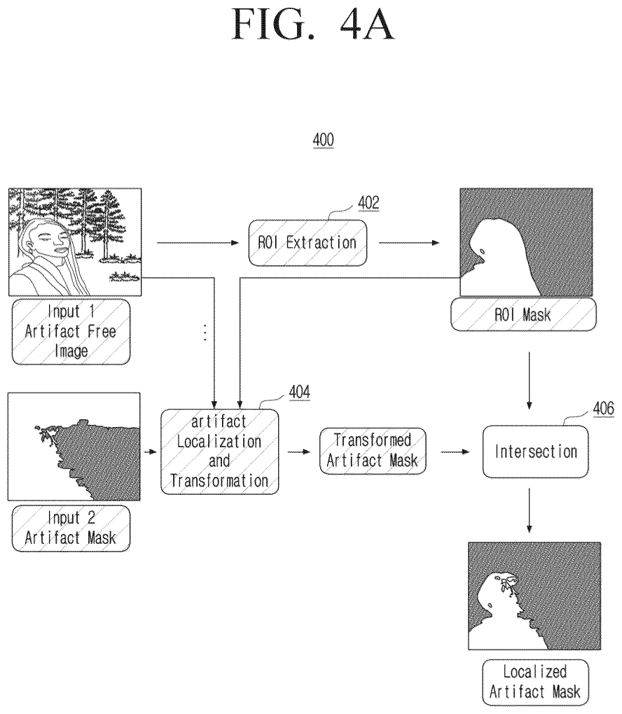

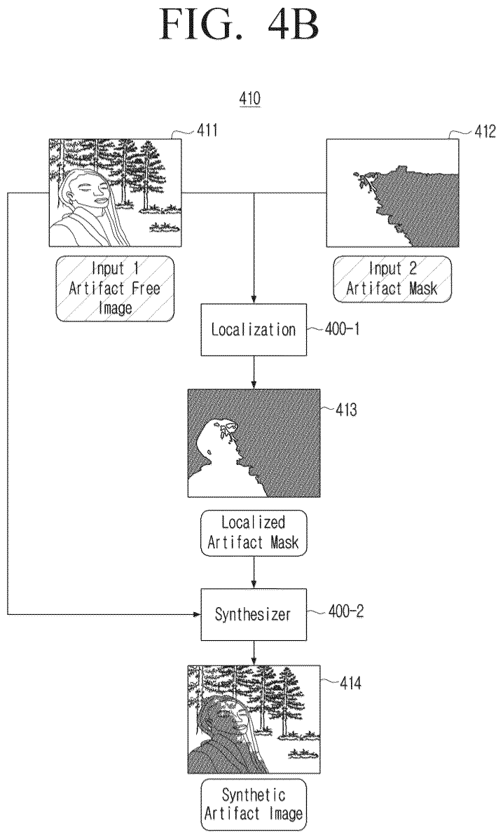

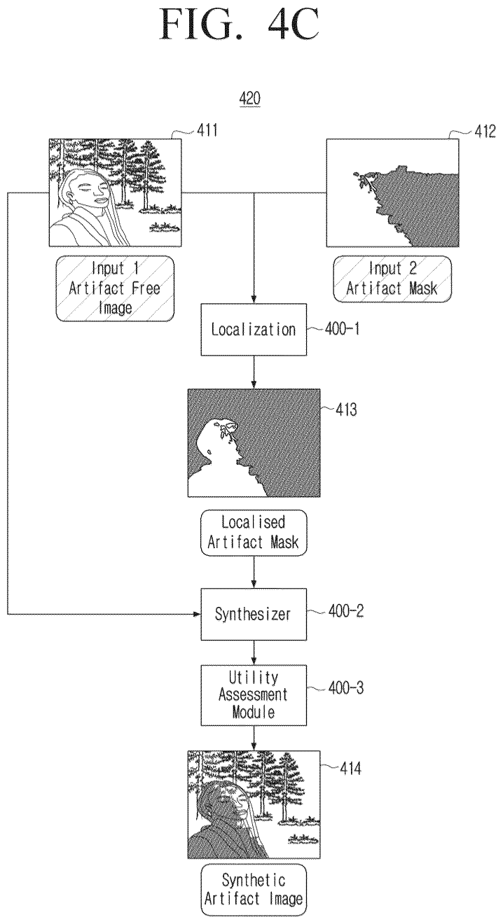

FIG. 4A illustrates an operational flow diagram depicting a process 400 for generating one or more localized artifact masks, in accordance with an embodiment of the present disclosure. The one or more localized artifact masks may be generated by the localization engine 218 as referred in FIG. 2 from one or more artifact masks associated with one or more artifacts. Generation of the one or more localized artifact masks may be based on generating one or more transformed artifact masks and utilizing a ROI mask from a number of ROI associated with one or more artifact free images.

Continuing with the above embodiment, the process 400 may include extracting (or obtaining) (step 402) the ROI mask associated with the one or more artifact free images. The ROI mask may be determined by the ROI extraction engine 216 from the number of ROI. In an embodiment, one or more ROI from the number of ROI may be the ROI mask.

Moving forward, the process 400 may proceed towards generating (step 404) one or more transformed artifact masks by applying at least one localization parameter amongst a number of localization parameters to the one or more artifact masks. The one or more transformed artifact masks may be generated by applying the at least one localization parameter amongst the number of localization parameters to the one or more artifact masks. Examples of the number of localization parameters may include, but are not limited to, a translation, a rotation, a shear, a flip, and a scaling associated with the one or more artifact masks. In an embodiment, the number of localization parameters may be generated by computing a size and dimensions associated with the ROI mask. Further, a number of pre-defined localization parameters of the one or more artifact masks may be adjusted according to the size and the dimensions of the ROI mask for generating the number of localization parameters.

Continuing with the above embodiment, the process 400 may include (step 406) generating the one or more localized artifact masks by placing the one or more transformed artifact masks on the ROI mask.

FIG. 4B illustrates an operational flow diagram depicting a process 410 for generating one or more synthetic artifact images, in accordance with an embodiment of the present disclosure.

Continuing with the above embodiment, the process 410 may use a localizer 400-1 and a synthesizer 400-2. The localizer 400-1 may perform a plurality of steps (402, 404, 406) in FIG. 4A. The localizer 400-1 may be localization engine 218 in FIG. 2. The utility assessment module 400-3 may be the synthesizer engine 220 in FIG. 2.

Continuing with the above embodiment, the localizer 400-1 may receive one or more artifact free images 411 (input 1) and one or more artifact masks 412 (input 2). The localizer 400-1 may generate one or more localized artifact masks 413 based on the one or more artifact free images 411 (input 1) and the one or more artifact masks 412 (input 2). The localizer 400-1 may transmit the generated one or more localized artifact masks 413 to the synthesizer 400-2.

Continuing with the above embodiment, the synthesizer 400-2 may receive the one or more localized artifact masks 413 from the localizer 400-1. The synthesizer 400-2 may receive the one or more artifact free images 411 (input 1). The synthesizer 400-2 may generate one or more synthetic artifact images 414 based on the one or more localized artifact masks 413 and the one or more artifact free images 411 (input 1).

FIG. 4C illustrates an operational flow diagram depicting a process 420 for generating one or more synthetic artifact images by using a utility assessment module, in accordance with an embodiment of the present disclosure.

Continuing with the above embodiment, the process 420 may use the localizer 400-1, the synthesizer 400-2 and an utility assessment module 400-3. The localizer 400-1 may perform a plurality of steps (402, 404, 406) in FIG. 4A. The localizer 400-1 may generate one or more localized artifact masks 413 in FIG. 4B. The synthesizer 400-2 may generate one or more synthetic artifact images 414 in FIG. 4B.

Continuing with the above embodiment, the synthesizer 400-2 may transmit the generated one or more localized artifact masks 413 to the utility assessment module 400-3. The utility assessment module 400-3 may be the UAM engine 222 in FIG. 2. The utility assessment module 400-3 may analyze the one or more synthetic artifact images 414 to detect a presence of one or more artifacts represented by the one or more localized artifact masks 413 in the one or more synthetic artifact images 414.

Continuing with the above embodiment, the utility assessment module 400-3 may determine that the one or more artifacts represented by the one or more localized artifact masks 413 is present in the one or more synthetic artifact images 414.

Continuing with the above embodiment, the utility assessment module 400-3 may provide feedback the localizer 400-1 and the synthesizer 400-2 for varying one of a plurality of localization parameters and one or more illumination parameters in response to determining that the one or more artifacts represented by the one or more localized artifact masks 413 is absent in the one or more synthetic artifact images 414.

Continuing with the above embodiment, the utility assessment module 400-3 may transmit the one or more synthetic artifact images 414 to output engine 224 in FIG. 2, in response to determining that the one or more artifacts represented by the one or more localized artifact masks 413 is in the one or more synthetic artifact images 414.

In another embodiment, the utility assessment module 400-3 may transmit a signal, indicating that the one or more artifacts is in the one or more synthetic artifact images 414, to output engine 224 in FIG. 2, in response to determining that the one or more artifacts represented by the one or more localized artifact masks 413 is in the one or more synthetic artifact images 414.

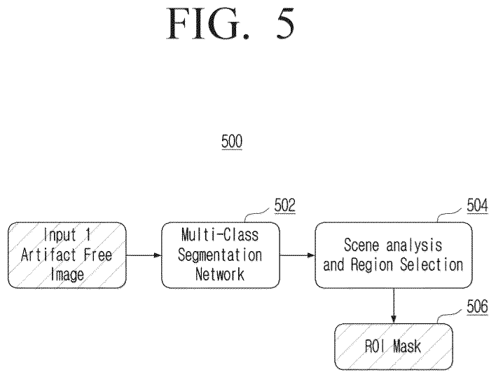

FIG. 5 illustrates an operational flow diagram depicting a process 500 for determining a ROI mask, in accordance with an embodiment of the present disclosure. The ROI mask may be determined by the ROI extraction engine 216 as referred in FIG. 2. The ROI mask may be amongst a number of ROI from one or more artifact free images.

Continuing with the above embodiment, the process 500 may include obtaining (step 502) one or more segmentation masks of one or more pre-defined categories. The one or more segmentation masks may depict contextual information associated with the number of ROI related to the one or more artifact free images. The contextual information may include one or more pre-defined categories of regions in the one or more artifact free images. Examples of the one or more pre-defined categories of regions may include, but are not limited to, a human mask, a road, a building, and a wall. The one or more segmentation masks may be obtained through a multi-class segmentation network. The multi-class segmentation network may be a Convolutional Neural Network (CNN) based multi-class segmentation network configured to extract binary masks of the one or more ROI from the one or more artifact free images.

Furthermore, the process 500 may include analyzing (step 504) a scene depicted by the one or more artifact free images to identify a category of the one or more artifact free images. The category may be one or more of an indoor category, an outdoor category, a human portrait, a generic image. More categories may be added for the analysis. The analysis may filter the one or more artifact free images based on the category and allow synthetic data generation only on specific scenes if required.

Continuing with the above embodiment, the process 500 may include determining (step 506) one or more ROI from the number of ROI as the ROI mask based on the one or more categories or regions and the category associated with the one or more artifact free images. In an embodiment, if it is determined that two or more binary masks of the one or more categories of regions is obtained in the one or more artifact free images such as a human and a building, either one mask as ROI mask or combine multiple ROI mask can be selected to form a single large ROI mask.

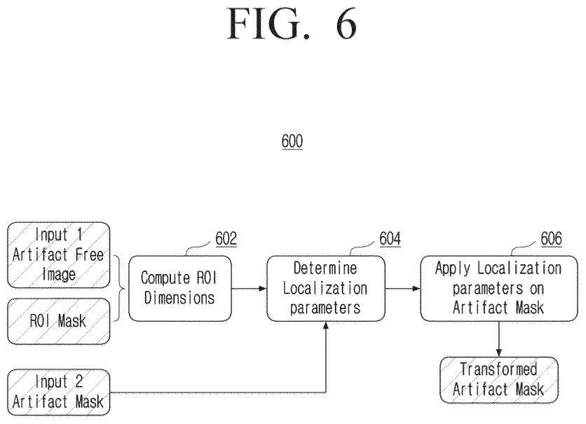

FIG. 6 illustrates an operational flow diagram depicting a process 600 for generating one or more transformed artifact masks, in accordance with an embodiment of the present disclosure. The one or more artifact masks may be generated by the localization engine 218 as referred in FIG. 2. The one or more transformed artifact masks may be generated from one or more artifact masks representing one or more artifacts to be applied on one or more artifact free images.

Continuing with the above embodiment, the process 600 may include computing (step 602) a size and dimensions related to the ROI mask.

Moving forward, the process 600 may include adjusting (step 604) a number of pre-defined localization parameters of the one or more artifact masks according to the size and the dimensions of the ROI mask and thereby generating the plurality of localization parameters

Subsequently, the process 600 may include (step 606) applying at least one localization parameter amongst the number of localization parameters to the one or more artifact masks for generating the one or more transformed artifact masks.

In an embodiment of the present disclosure, the process 600 may include varying the number of pre-defined localization parameters of the artifact mask within a range to generate at least one other set of number of localization parameters. Further, the process 600 may include applying the at least one other set of the number of localization parameters on the one or more artifact masks to generate at least one other transformed artifact mask. Moving forward, the process 600 may further include generating at least one other localized artifact mask by placing the at least one other transformed artifact mask on the ROI mask for further generating at least one other artifact image.

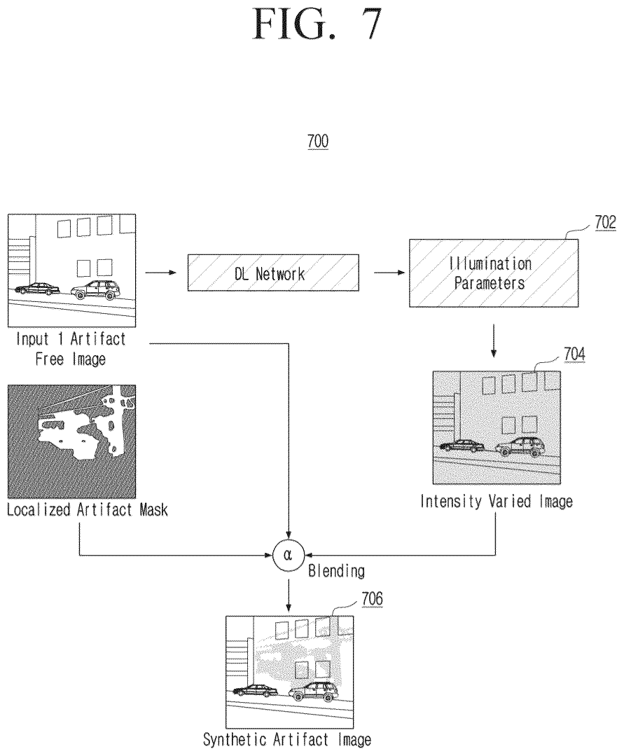

FIG. 7 illustrates an operational flow diagram depicting a process 700 for generating one or more artifact images by the synthesizer engine 220, in accordance with an embodiment of the present disclosure.

The process 700 may include determining (step 702) one or more illumination parameters associated with one or more artifact free images using a DL network.

Moving forward, the process 700 may include generating (step 704) one or more varied intensity images by applying the one or more illumination parameters to the one or more artifact free images. The one or more illumination parameters may be determined based on an illumination intensity associated with the one or more artifacts free images using the DL network.

Further, the illumination intensity of the one or more artifacts free images may be varied based on the one or more illumination parameters to generate the one or more varied intensity images. In an embodiment, the process 700 may include adjusting the one or more illumination parameters within a range to generate at least one other set of one or more illumination parameters. The at least one other set of one or more illumination parameters may be applied to the one or more artifact free images to generate at least one other varied intensity image.

Moving forward, the process 700 may include generating (step 706) the one or more artifact images comprising one or more localized artifact masks. The generation may be based on blending the one or more artifact free images and the one or more varied intensity images with the one or more localized artifacts masks. The generation may further include applying one or more edge softening operations on the one or more localized artifact masks for blending the one or more artifact free images and the one or more varied intensity images with the one or more localized artifacts masks. In an embodiment, the one or more edge softening operations may be applied on the one or more localized artifact masks to produce one or more variations of crisp to soft artifact edges. In an embodiment, where the at least one other varied intensity image is generated, the at least one other varied intensity image may be blended with the one or more localized artifacts masks along with the one or more artifact free images.

In an embodiment, a subset of the one or more illumination parameters related to color tints may be varied in a certain range to vary color properties of the one or more artifacts. In an embodiment, an estimation of a direction of light using a luminance image obtained from the one or more artifact free images may be performed by determining a gradient direction in a luminance image. Further, a non-uniform intensity variation from light to dark may be applied to the direction of light. In an embodiment, the synthesizer engine 220 may be trained with glare data to generate a brightened varied intensity image related to the one or more varied intensity images so as to generate a glare effect.

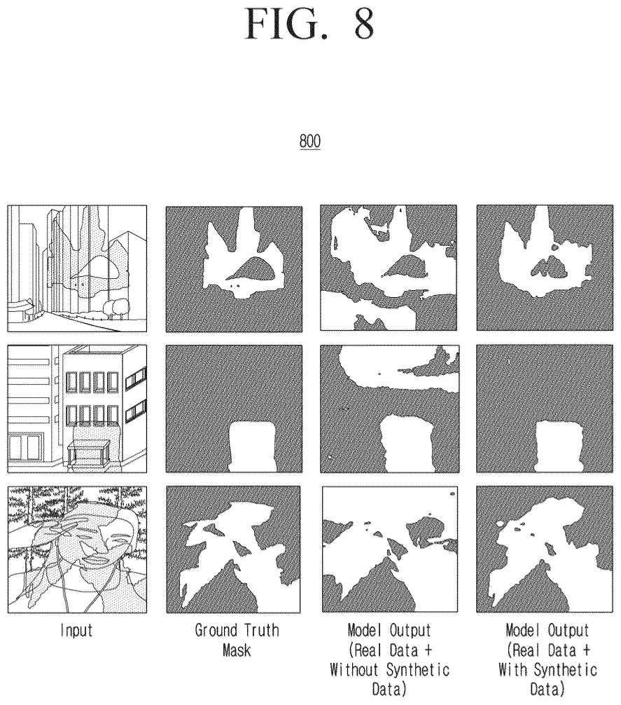

FIG. 8 illustrates a use case diagram 800 depicting results related to a Shadow Detector State of The Art (SoTA) DL Model, in accordance with an embodiment of the present disclosure. SoTA Shadow detector models trained with only real data and trained with the real data and synthetic data are compared. Adding synthetic data improves an accuracy of the shadow detector models. The shadow detector models are AI trained models. Table 1 mentioned below depicts a shadow removal model quantitative evaluation.

TABLE 1
Shadow Removal Model Quantitative Evaluation

| Model without Synthetic Data | | | | Model with Synthetic Data | | |
|---|---|---|---|---|---|---|
| | RMSE | RMSE | | LAB RMSE | LAB RMSE | LAB |
| | (Shadow | (Non-Shadow | RMSE | (Shadow | (Non-Shadow | RMSE |
| Test Set | Region) | Region) | (Total) | Region) | Region) | (Total) |
| Real | 4.31 | 1.09 | 2.07 | 2.42 | 0.83 | 1.28 |
| Generic | | | | | | |
| Data | | | | | | |
| Real | 5.53 | 1.34 | 3.61 | 2.62 | 0.83 | 1.76 |
| Portrait | | | | | | |
| Data | | | | | | |

Table 1 depicts a shadow removal model quantitative evaluation.

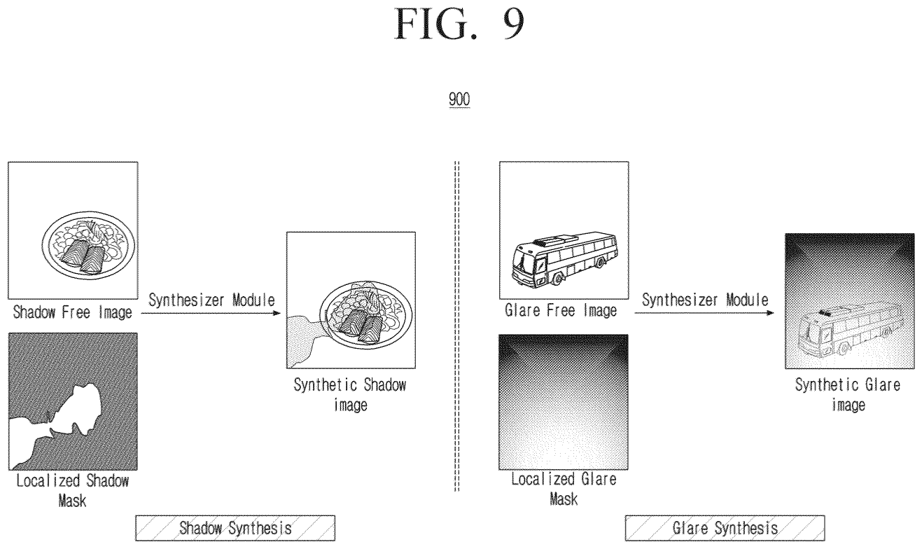

FIG. 9 illustrates another use case diagram 900 depicting a large-scale artifact synthesis for synthetic dataset, in accordance with an embodiment of the present disclosure. The large-scale artifact synthesis may be related to a shadow synthesis and a glare synthesis.

The method may be used to automatically synthesize large scale paired datasets for training artifact removal methods like shadow removal, and glare removal or the like. Given a pool of artifact free images and a set of artifact masks, a framework proposed in the present disclosure may be used to generate large scale artifact images with diverse variations. This provides an image without the artifact, an image with the artifact and a mask demarcating the artifact region.

In an embodiment, for enhancing an aesthetic appeal of an image, shadows and glares may often be used by professional photographers for adding artistic elements to their photos and enhance their aesthetic appeal. With the localization engine 218 and the synthesizer engine 220 of the present disclosure, it may be learnt to mimic these styles.

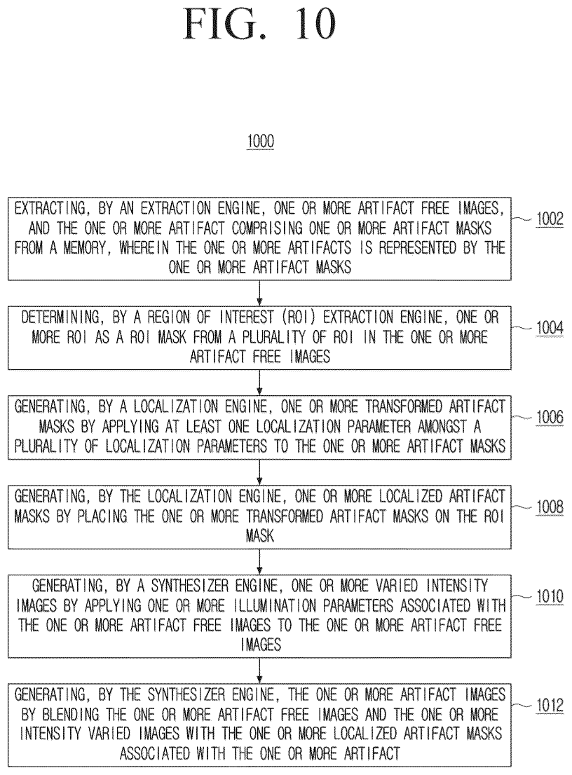

FIG. 10 illustrates a flow diagram depicting a method 1000 for generating one or more artifact images using one or more artifacts masks, in accordance with an embodiment of the present disclosure. The method 1000 may be implemented by the system 102 using components thereof, as described above. In an embodiment, the method 1000 may be executed by the web content extraction engine 214, the ROI extraction engine 216, the localization engine 218, the synthesizer engine 220, the UAM engine 222, and the output engine 224. Further, for the sake of brevity, details of the present disclosure that are explained in detail in the description of FIG. 1 to FIG. 9 are not explained in detail in the description of FIG. 10.

In operation 1002, the method 1000 includes extracting (or obtaining), by an extraction engine, one or more artifact free images, and the one or more artifacts comprising one or more artifacts masks from a memory, wherein the one or more artifacts is represented by the one or more artifact masks.

In operation 1004, the method 1000 includes, determining, by a Region Of Interest (ROI) extraction engine, one or more ROI as a ROI mask from a plurality of ROI in the one or more artifact free images.

In operation 1006, the method 1000 includes generating, by a localization engine, one or more transformed artifact masks by applying at least one localization parameter amongst a plurality of localization parameters to the one or more artifact masks.

In operation 1008, the method 1000 includes, generating, by the localization engine, one or more localized artifact masks by placing the one or more transformed artifact masks on the ROI mask.

In operation 1010, the method 1000 includes, generating, by a synthesizer engine, one or more varied intensity images by applying one or more illumination parameters associated with the one or more artifact free images to the one or more artifact free images.

In operation 1012, the method 1000 includes, generating, by the synthesizer engine, the one or more artifact images by blending the one or more artifact free images and the one or more varied intensity images with the one or more localized artifact masks associated with the one or more artifacts.

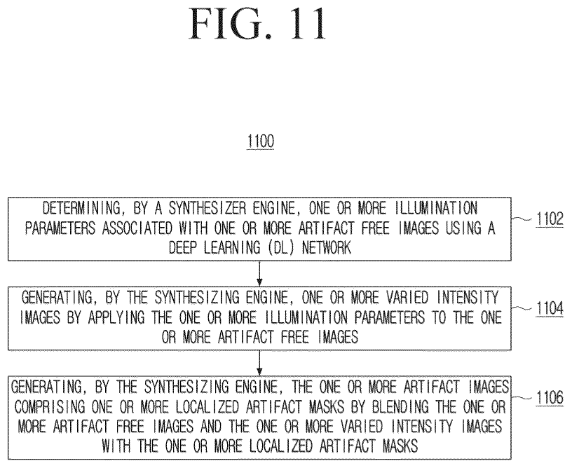

FIG. 11 illustrates a flow diagram depicting a method 1100 for generating illumination of one or more artifacts, in accordance with an embodiment of the present disclosure. The method 1100 may be implemented by the system 102 using components thereof, as described above. in an embodiment, the method 1100 may be executed by the synthesizer engine 220. Further, for the sake of brevity, details of the present disclosure that are explained in detail in the description of FIG. 1 to FIG. 10 are not explained in detail in the description of FIG. 11.

In operation 1102, the method 1100 includes determining, by a synthesizer engine, one or more illumination parameters associated with one or more artifact free images using a Deep Learning (DL) network.

In operation 1104, the method 1100 includes generating, by the synthesizing engine, one or more varied intensity images by applying the one or more illumination parameters to the one or more artifact free images.

In operation 1106, the method 1100 includes, generating, by the synthesizing engine, the one or more artifact images comprising one or more localized artifact masks by blending the one or more artifact free images and the one or more varied intensity images with the one or more localized artifacts masks.

While specific language has been used to describe the present disclosure, any limitations arising on account thereto, are not intended. As would be apparent to a person in the art, various working modifications may be made to the method to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

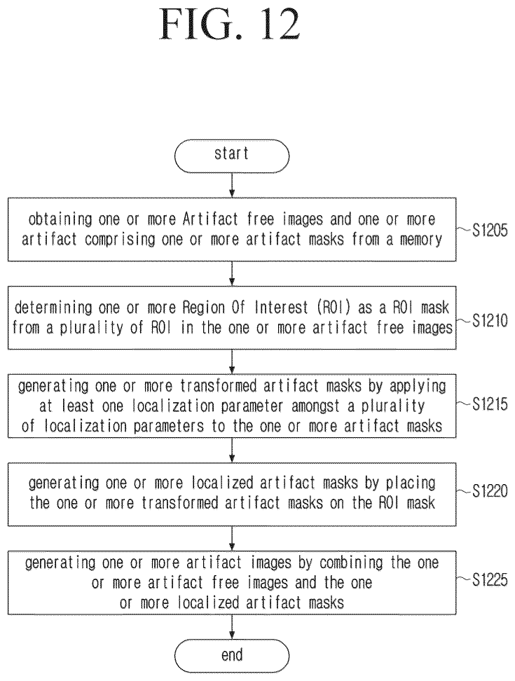

FIG. 12 is a flowchart illustrating a method for controlling an electronic device according to an embodiment.

A method of controlling the electronic device 100 according to an embodiment may include obtaining one or more artifact free images and one or more artifacts comprising one or more artifact masks from a memory in operation S1205, determining one or more Region Of Interest (ROI) as a ROI mask from a plurality of ROI in the one or more artifact free images in operation S1210, generating one or more transformed artifact masks by applying at least one localization parameter amongst a plurality of localization parameters to the one or more artifact masks in operation S1215, generating one or more localized artifact masks by placing the one or more transformed artifact masks on the ROI mask in operation S1220, and generating one or more artifact images by combining the one or more artifact free images and the one or more localized artifact masks in operation S1225.

The method of controlling the electronic device 100 may include generating one or more varied intensity images by applying one or more illumination parameters associated with the one or more artifact free images to the one or more artifact free images and wherein the generating the one or more artifact images comprises generating the one or more artifact images by combining the one or more artifact free images, the one or more localized artifact masks and the one or more varied intensity images.

The method of controlling the electronic device 100 may include analyzing the one or more artifact images to detect a presence of the one or more artifacts represented by the one or more localized artifact masks in the one or more artifact images, determining that the one or more artifacts represented by the one or more localized artifact masks is present in the one or more artifact images and producing the one or more artifact images comprising the one or more artifacts represented by the one or more localized artifact masks as an output.

The method of controlling the electronic device 100 may include providing feedback for varying one of the plurality of localization parameters and one or more illumination parameters in response to determining that the one or more artifacts represented by the one or more localized artifact masks is absent in the one or more artifact images.

The determining the one or more ROI as the ROI mask may include obtaining, from the one or more artifact free images, one or more segmentation masks of one or more pre-defined categories depicting contextual information associated with the plurality of ROI associated with the one or more artifact free images and determining the one or more ROI as the ROI mask based on the one or more segmentation masks of one or more categories.

The plurality of localization parameters may be determined based on computing a size and dimensions associated with the ROI mask and adjusting a plurality of pre-defined localization parameters of the one or more artifact masks according to the size and the dimensions of the ROI mask and generating the plurality of localization parameters.

The method of controlling the electronic device 100 may include varying the plurality of pre-defined localization parameters of the artifact mask within a range to generate at least one other set of plurality of localization parameters, applying the at least one other set of the plurality of localization parameters on the one or more artifact masks to generate at least one other transformed artifact mask and generating at least one other localized artifact mask by placing the at least one other transformed artifact mask on the ROI mask for further generating at least one other artifact image.

The plurality of localization parameters may include at least one of a translation, a rotation, a shear, a flip, and a scaling associated with the one or more artifact masks.

The one or more artifact may be a region of shadow casted by one or more of an object, a scene, and a living being and the one or more artifact masks represents a location of the one or more artifacts in the image using a binary mask image.

The one or more artifact free images may be an image of one or more of an object, a scene, and a living being.

The one or more artifacts represented by the one or more artifact masks and the one or more artifact free images may be pre-stored in the memory.

The controlling method of the electronic device according to an embodiment may be implemented as a program and provided to the electronic device. In particular, a program including a controlling method of the electronic device may be stored in a non-transitory computer readable medium and provided.

A non-transitory computer readable medium storing computer instructions executed by the processor 120 of the electronic device 100 may control the electronic device 100 to perform operations including displaying an image signal inputted through the inputter 115. The outputting an audio signal synchronized with the displayed image signal and the displaying caption information corresponding to the audio signal outputted during a preset previous time based on a point of time of inputting the user command may be included.

The various embodiments described above may be implemented in a recordable medium which is readable by computer or a device similar to computer using software, hardware, or the combination of software and hardware. By hardware implementation, the embodiments of the disclosure may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electric units for performing other functions. In some cases, embodiments described herein may be implemented by the processor 120 itself. According to a software implementation, embodiments such as the procedures and functions described herein may be implemented with separate software modules. Each of the above-described software modules may perform one or more of the functions and operations described herein.

While not restricted thereto, an example embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an example embodiment may be written as a computer program transmitted over a computer-readable transmission medium, such as a carrier wave, and received and implemented in general-use or special-purpose digital computers that execute the programs. Moreover, it is understood that in example embodiments, one or more units of the above-described apparatuses and devices can include circuitry, a processor, a microprocessor, etc., and may execute a computer program stored in a computer-readable medium.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method for controlling an electronic device, the method comprising:
obtaining one or more artifact free images and one or more artifacts represented by one or more artifact masks;
obtaining a region of interest (ROI) mask identifying one or more ROIs in the one or more artifact free images;
generating one or more transformed artifact masks by applying at least one localization parameter amongst a plurality of localization parameters to the one or more artifact masks;
generating one or more localized artifact masks by placing the one or more transformed artifact masks on the ROI mask; and
generating one or more artifact images by combining the one or more artifact free images and the one or more localized artifact masks.

2. The method as claimed in claim 1, further comprising:
generating one or more varied intensity images by applying one or more illumination parameters to the one or more artifact free images; and
wherein the generating the one or more artifact images comprises:
generating the one or more artifact images by combining the one or more artifact free images, the one or more localized artifact masks and the one or more varied intensity images.

3. The method as claimed in claim 1, further comprising:
analyzing the one or more artifact images to detect a presence of the one or more artifacts represented by the one or more localized artifact masks in the one or more artifact images;
determining that the one or more artifacts represented by the one or more localized artifact masks is present in the one or more artifact images; and
producing the one or more artifact images comprising the one or more artifacts represented by the one or more localized artifact masks as an output.

4. The method as claimed in claim 1, further comprising:
providing feedback for varying one of the plurality of localization parameters and one or more illumination parameters in response to determining that the one or more artifacts represented by the one or more localized artifact masks is absent in the one or more artifact images.

5. The method as claimed in claim 1, wherein the obtaining the ROI mask comprises:
obtaining, from the one or more artifact free images, one or more segmentation masks of one or more categories depicting contextual information associated with the plurality of ROIs; and
obtaining the ROI mask based on the one or more segmentation masks of the one or more categories.

6. The method as claimed in claim 1, wherein the plurality of localization parameters is determined based on:
computing a size and dimensions associated with the ROI mask; and
adjusting a plurality of pre-defined localization parameters of the one or more artifact masks according to the size and the dimensions of the ROI mask and generating the plurality of localization parameters.

7. The method as claimed in claim 6, further comprising:
varying the plurality of pre-defined localization parameters of the artifact mask within a range to generate at least one other set of plurality of localization parameters;
applying the at least one other set of the plurality of localization parameters on the one or more artifact masks to generate at least one other transformed artifact mask; and
generating at least one other localized artifact mask by placing the at least one other transformed artifact mask on the ROI mask for further generating at least one other artifact image.

8. The method as claimed in claim 1, wherein the plurality of localization parameters comprises at least one of a translation, a rotation, a shear, a flip, and a scaling associated with the one or more artifact masks.

9. The method as claimed in claim 1, wherein the one or more artifact comprises a region of shadow casted by one or more of an object, a scene, and a living being and the one or more artifact masks represent a location of the one or more artifacts in the image using a binary mask image.

10. The method as claimed in claim 1, wherein the one or more artifact free images capture an object, a scene, and a living being.

11. The method as claimed in claim 1, wherein the one or more artifacts represented by the one or more artifact masks and the one or more artifact free images are pre-stored in the electronic device.

12. An electronic device comprising:
a memory storing one or more instructions; and
a processor configured to execute the one or more instructions to:
obtain, from the memory, one or more artifact free images, and one or more artifacts represented by one or more artifact masks;
obtaining a region of interest (ROI) mask identifying one or more ROIs in the one or more artifact free images;
generate one or more transformed artifact masks by applying at least one localization parameter amongst a plurality of localization parameters to the one or more artifact masks;
generate one or more localized artifact masks by placing the one or more transformed artifact masks on the ROI mask; and
generate one or more artifact images by combining the one or more artifact free images and the one or more localized artifact masks.

13. The electronic device as claimed in claim 12, wherein the processor is further configured to:
generate one or more varied intensity images by applying one or more illumination parameters associated to the one or more artifact free images; and
generate the one or more artifact images by combining the one or more artifact free images, the one or more localized artifact masks and the one or more varied intensity images.

14. The electronic device as claimed in claim 12, wherein the processor is further configured to:
analyze the one or more artifact images to detect a presence of the one or more artifacts represented by the one or more localized artifact masks in the one or more artifact images;
determine that the one or more artifacts represented by the one or more localized artifact masks is present in the one or more artifact images; and
produce the one or more artifact images comprising the one or more artifacts represented by the one or more localized artifact masks as an output.

15. The electronic device as claimed in claim 12, wherein the processor is further configured to:
provide feedback for varying one of the plurality of localization parameters and one or more illumination parameters in response to determining that the one or more artifacts represented by the one or more localized artifact masks is absent in the one or more artifact images.

16. A non-transitory computer-readable storage medium storing a program that is executable by a processor to perform a method of controlling an electronic device, the method comprising
obtaining an artifact free image and an artifact mask identifying an artifact;
obtaining a localized artifact mask by applying at least one localization parameter to the artifact mask and adjusting a position of the artifact mask to overlap with a region of interest (ROI) included in the artifact free image; and
obtaining an artifact image by combining the artifact free image with the localized artifact mask.

17. The non-transitory computer-readable storage medium as claimed in claim 16,
wherein the at least one localization parameter comprises at least one of a translation, a rotation, a shear, a flip, and a scaling associated with the artifact mask.

18. The non-transitory computer-readable storage medium as claimed in claim 16, wherein the method further comprises:
determining the at least one localization parameter based on a size and a dimension of the ROI.
